(19) United States
(12) Patent Application Publication
(10) Pub. No.: US 2017/0264236 A1
(43) Pub. Date: Sep. 14, 2017

(54) Carbon Negative System

(71) Applicant: Yung Sheng Liu, Xiandian (TW)

(72) Inventor: Yung Sheng Liu, Xiandian (TW)

(21) Appl. No.: 15/390,564

(22) Filed: Dec. 26, 2016

Related U.S. Application Data
(63) Continuation-in-part of application No. 14/534,567, filed on Nov. 6, 2014, now abandoned.
(60) Provisional application No. 61/902,180, filed on Nov. 9, 2013.

(51) Int. Cl. H02S 20/23; H02S 99/00; A01G 7/04; F21S 9/03; A01G 9/20; A01G 9/24; A01G 9/26; A01G 1/00; H02S 40/38; A01G 9/14

(52) U.S. Cl. CPC H02S 20/23; H02S 40/38; H02S 99/00; A01G 7/045; A01G 9/14; A01G 9/20; A01G 9/243; A01G 9/26; A01G 1/001; F21S 9/03; F21Y 2115/10

(57) ABSTRACT

Carbon dioxide molecules can be fixed by growing plants through plant photosynthesis. When the photons that cause the plant synthesis are properly tuned to enhance plant photosynthesis and are generated by a combination of a solar panel of carbon footprint below a threshold and a LED light source of carbon footprint below a threshold and conversion efficiency above a threshold, more CO₂ molecule will be fix by the plant photosynthesis than emitted by the system.

### BACKGROUND

High concentration of carbon dioxide (CO₂) in the earth atmosphere threatens the future way of life on earth. Countries are taking steps to reduce carbon dioxide emission into the atmosphere, include-exploring more energy efficient power generation technologies and promoting energy conservation in a concerted effort to decrease the emission of carbon dioxide. During the 2015 United Nations Climate Change Conference in Paris, over 187 nations set an aggressive goal of limiting global temperature increase to 1.5° C. compared to pre-industrial levels.

It is also recognized that cleaner power generation technologies and energy conservation measures alone are not sufficient to solve the problem because even with a reduced amount of carbon dioxide and emitted at a slower rate, the net carbon dioxide concentration is still rising. In other words, it is still carbon positive.

The Intergovernmental Panel on Climate Change reported that deployment of large scale “carbon negative” cycles is needed by 2040. One method that is being discussed and under development is bio-energy with carbon capture and storage (BECCS or BioCCS). At the United Nations Climate Change Conference in 2011, the Organization for Economic Co-operation and Development (OCED) Environmental releases the Outlook to 2050 in which the authors commented on the need for negative emissions, stating that “achieving lower concentration targets (450 ppm) depends significantly on the use of BECCS”. And according to the Center for Carbon Removal (CCR), BioCCS has the potential to fix significant amounts of the greenhouse gas (GHG) carbon dioxide from the atmosphere while producing fuels or electricity or both.

Carbon capture and storage is being tested by Clean Energy System (CES) of Sacramento, Calif. in a feasibility study for a small-scale commercial plant at Kimberlina Power Plant in Bakersfield, Calif. The most distinctive element of the CES is an oxy-combustor, similar to one used in rocket engines that generates steam by burning a clean, gaseous fuel in the presence of gaseous oxygen and water. The clean fuel is prepared by processing a conventional fossil fuel such as coal-derived syngas, refinery residues, biomass or biodigester gas, or natural or landfill gas.

Combustion takes place at near-stoichiometric conditions to produce a mixture of steam and CO₂ at high temperature and pressure. The steam conditions are suitable for driving a conventional or advanced steam turbine-generator, or a gas turbine modified to be driven by high-temperature steam. After passing through the turbine, the steam and CO₂ mixture is condensed, cooled, and separated into water and CO₂. The CO₂can then be sequestered in liquid form underneath the earth surface, thus removed from the earth atmosphere.

Mother Nature is also doing her part in eliminating carbon dioxide through the natural phenomenon of plant photosynthesis. Green plants, including algae, with the aid of its chlorophyll and sunlight, convert water and carbon dioxide into carbohydrate. In addition, scientists and engineers are discovering the benefit of using artificial lighting in assisting plant growth, Miriai Co. Ltd of Japan recently announced the result of its 800 square meter plant-grow factory utilizing LED lighting in producing 10,000 lettuces per day. The LED lighting, replacing fluorescent lamps, reduces the electricity consumption of the factory by 40% and improved the plant growth by 50%, as reported by the Company.

### SUMMARY OF THE INVENTION

The Inventor has studied the environment impact by the increasing of carbon dioxide in the earth atmosphere and arrived at the following discovery:

### BioCCS

The BioCCS technology is an important technological advancement in dealing with the problem of increasing carbon dioxide concentration in the earth atmosphere. However, BioCCS technology has shortcomings. Fundamentally, with this method the carbon dioxide is only captured but not eliminated—it is merely sequestered from the earth atmosphere and stored either on earth or under the earth's surface in a compact (liquefied) form. Permanent leak-proof storage system and technology is not yet available at present. When the liquefied and pressurized carbon dioxide eventually escapes from the storage and back to the atmosphere, the result of the BioCCS system will be compromised.

Secondly, the BioCCS systems, such as the CES system described above, inherently have a heavy front-end, carbon footprint. Without a more comprehensive knowledge to the Life Cycle Assessment (LCA) of its total life cycle carbon emission, including construction, operation, and maintenance, its net benefit to carbon dioxide reduction effort cannot be determined with certainty.

### Plant Photosynthesis

Natural plant photosynthesis depends on the amount of available sunlight on the light absorbing plant surface such as leaves. Sunlight on earth is diffused—it is about one kilowatt per square meter at the earth surface when the sun is at zenith, and only a small portion of sun's spectrum can induce plant photosynthesis. The continuous deforestation by human activities further reduces the amount of plants available for plant photosynthesis and diminishes the nature's contribution to balancing carbon dioxide in earth's atmosphere.

Using artificial lighting to aid plant growth is viable, and LED lighting does reduce energy consumption compared to other lighting sources. However, whether a plant factory can achieve carbon negativity depends on many factors including the carbon footprints of the power source that drives the LED and the LED itself.

With this realization, Inventor endeavored to invent and disclose in this paper methods and systems that, when followed in construction and operating the systems as described, can achieve carbon negativity.

The invented method includes the step of selecting power sources that meet carbon footprint threshold; selecting lighting sources that meet both carbon footprint threshold and conversion efficiency and are configured to generate photons in the proper spectral range. Inventor discloses in this paper means for ascertaining through published data from commercial sources to establish selection criteria for the power source and lighting source. By following the specification presented in this paper, a skilled artisan can construct and operate systems that, during the designed life span of the system, will achieve net carbon dioxide negativity.

### Definition of Several Terms

The terms used in this disclosure generally have their ordinary meanings in the art within the context of the invention. Certain terms are discussed below to provide additional guidance to the practitioners regarding the description of the invention. It will be appreciated that same thing can be said in more than one way. Consequently, alternative language and synonyms may be used.

Life Cycle Assessment (LCA) or cradle to grave analysis (CGA) in the context of this paper refers to a technique to assess environmental impacts associated with all stages of life of a product or system from raw material extraction through materials processing, manufacture, distribution, use, repair and maintenance, and disposal or recycling. A typical total energy inventory of a system includes the following:

Eₘₐₜ; energy needed to extract material for the system;

E_{manuf}: energy needed to manufacture the system;

Eₜᵣₐₙₛ: energy needed to transport materials used during the life cycle of the system;

Eᵢₙₛₜ: energy needed to install the system;

E_{EOL}: energy needed for the end-of-life management; and

Eₐₒₚₑᵣ: prorated energy needed to operate and maintain the system.

Solar Panel or Photovoltaic (PV) Panel or Solar Cell Panel in the context of this paper interchangeably refers to a panel designed to absorb the sun's rays as a source of energy for generating electricity. A photovoltaic (PV) module is a packaged and connected assembly of typically 8×10 solar cell array. Each module is rated by its DC output power under standard test conditions, and typically ranges from 100 to 365 watts. A photovoltaic system typically includes a panel or an array of solar modules, and sometimes a power inverter, a battery, a solar tracker, and interconnection wiring.

Negative carbon dioxide emission or negative emission or process that is carbon negative or carbon negativity in the context of this paper describes a system or a process of operating a system to permanently fix greenhouse gas carbon dioxide from the earth's atmosphere. Negative emissions is different from reducing emissions, as the former produces an outlet of carbon dioxide from the Earth's atmosphere, whereas the latter decreases the inlet of carbon dioxide to the atmosphere.

Biomass refers to organic matter of living, or recently living organisms. Biomass can be used as a source of energy. As an energy source, other than food, biomass can either be used directly via combustion to produce heat, or indirectly after converting it to various forms of biofuel. In the context of this paper, biomass also describes the end product of the operation of a carbon negative system in the form of new growth of a plant, including algae.

CO₂ e per kWh is an unit used in the power industry in measuring life-cycle greenhouse gas emissions. It involves calculating the global-warming potential of electrical energy sources through life-cycle assessment of the energy sources and presents the results in units of global warming potential per unit of electrical energy by that source. The scale uses the global warming potential unit—the carbon dioxide equivalent (CO₂ e), and the unit of electrical energy—the kilowatt hour (kWh). As an example, if the published number of carbon footprint for a coal burning power plant is 1,100 g CO₂ e/kWh, it represents that for the life span of the power plant it emits 1,100 grams (1.1 kg) of CO₂ and its equivalents for each kWh of electricity produced.

Light-Emitting-Diode (LED) in the context of this paper refers to a semiconductor light source. It may have a p-n junction diode, which emits light when a forward voltage is impressed across the p-n junction and causes a current to flow across it so that electrons are able to recombine with holes within the device to release energy in the form of photons. This effect is called, electroluminescence, and the color of the light (corresponding to the energy of the photon) is determined by the energy band gap of the semiconductor. An LED is often small in area (less than 1 mm²). GaN or InGaN based LED emits blue light (peak at about 465 nm); other types of materials such as GaAlAs emit red lights (at about 700 nm).

Phosphor-based LED involves coating LED of one color (mostly blue LED) with phosphors of different colors to form a different light (often at longer wavelengths); the resultant LED is called phosphor-based or phosphor-converted LED (pcLED). A fraction of the (blue) light undergoes the Stokes shift and transforms from shorter wavelengths to longer ones. Depending on the color of the original LED, phosphors of different colors can be employed. If several phosphor layers of distinct colors are applied, the emitted spectrum is broadened. Phosphor-based LED efficiency losses are due to the heat loss from the Stokes shift and also other degradation issues.

Conversion Efficiency of LED in the context of this paper refers to the external quantum efficiency of the LED. It measures the ratio of the number of photons emitted from the LED to the electrons passing through the device'in other words, how efficiently the LED converts electric power, in terms of electrons, to photons and allows them to escape. Currently, some phosphor based LEDs can reach 50% conversion efficiency.

### BRIEF DESCRIPTION OF DRAWING FEATURES

FIG. 1 depicts several components of a carbon negative system embodying some aspects of this invention.

FIG. 2 depicts a carbon negative system including a greenhouse and embodying some aspects of this invention

FIG. 3 depicts a process of constructing a carbon negative system embodying some aspects of this invention.

### SEVERAL ASPECTS OF A CARBON NEGATIVE SYSTEM

### Conversion of Carbon Emission

The realization of a carbon negative system involves recognition of the carbon footprint of the energy source that powers the system. For example the published data from First Solar Inc. of Temple, Ariz., U.S. show that by 2012, it produced 7 GW of PV solar modules with CO₂ emission of 1.4 Megatons based on the LCA.

Inventor converted this figure into the g CO₂ e/kWh unit as follows:

7 GW=7×10⁶ kW; 1.4 Megaton of CO₂=1.4×10¹² grams;

According to the publication from First Solar, the installed solar modules produce 1.3 TeraWatt-hour of electricity per GW per year so 7 GW of solar panel produces 9.1×10⁹ kWh of electricity per year. With a LCA estimation of total CO₂ emission of 1.4 Megatons, and with an estimated lifespan of the PV modules of 25 years, the figure of merit for the First Solar Inc. PV modules (its carbon footprint) is 6.15 g CO₂ e/kWh.

### The LED Lighting for Photon Generation

Inventor also discovered based on published data fron Osram Licht AG of Germany, the LCA carbon footprint of an 8 watt LED as an example to use for converting electrical power into photons for plant photosynthesis. The material list of LED lamps includes the following ingredients: glasses, ferrous metal, aluminum and other non-ferrous metals, plastic, electronic components resin compound, and minute quantities of cement and mercury. The total carbon footprint in the manufacturing phase for the 8 watt LED lamp is listed as 2.4 kg CO₂ e. The published estimated life span for the LED is 25,000 hours (2.85 years). Inventor calculated the CO₂ emission from this Osram LED to be 12 g CO₂ e/kWh for each LED.

The conversion efficiency is listed 30.4% for this LED (1 kWh output from LED requires 3.29 kWh input energy). For each kWh of energy enters the LED, 0.304 kWh is converted into photons and the balance goes to heat generation. The operating phase of carbon footprint then can be attributed to the carbon footprint of the power source. And for each joule of energy

There is no data from Osram on the recycle or disposal phase of the LED. The production phase and the operating phase will be used in this paper as a lower threshold for the intended purpose of constructing a carbon negative system.

### The Plant Photosynthesis

For purpose of illustration, Inventor uses photons of 450 nm wavelength as example to calculate its energy. The energy of a photon is equal to E=hc/λ, where E is energy, h is the Planck's constant, c is the speed of light, and λ is its wavelength. The energy of a photon with the exemplary wavelength of 450 nm has the energy of 4.17×10⁻¹⁹ joules, or one joule of energy is equivalent to 2.4×10¹⁸ photons with the wavelength of 450 nm. One kilowatt hour of energy is equal to 3.6×10⁶ joules; or equivalent to 8.64×10²⁴ photons with the wavelength around 450 nm.

### CO₂ Molecules Fixation by Plant Photosynthesis

Inventor studied plant photosynthesis and recognized that because the solar spectrum covers a wide range (from ultra-violet to infrared) at least 60% of the photons from nature sun light do not actively participate in natural plant photosynthesis, and even if absorbed by the plant will turn into heat. With natural sun light, it takes 10 photons to convert one CO₂ into biomass by plants including algae, according to the following formula:

CO₂+H₂O+10 photons=CH₂O+O_{2.}

Inventor also recognized that the conversion efficiency doubles when the impinging photons on plant surface having wavelengths around 480 nm or 650 nm.

CO₂+H₂O+5 photons=CH₂O+O₂.

According to the above formula, every 5 photons of the proper wavelength can convert one CO₂ molecule into one biomass molecule and in the process eliminate the CO₂ molecule from earth atmosphere. The following formula depicts the number of photons that will take to fix one kilogram of CO₂:
a) number of CO₂ molecules in, one kilogram is 1 kg=1×10³ grams=1×10³/44.01 grams per mole=2.27×10¹ moles=2.27×10¹×6.02×10²³ molecules per mole=1.37×10²⁵ molecules
b) number of photons to fix 1 kilogram of CO₂ is 1.37×10²⁵×5 photons=6.84×10²⁵ photons.
c) energy for fixing 1 kg of CO₂ through plant photosynthesis is 6.84×10²⁵ photons/8.64×10²⁴ photon/kWh=7.92 kWh.

### A CO₂ Fixing System of PV Module and LED Light Source

Inventor tested a system comprises an exemplary PV module manufactured by First Solar coupled to an exemplary LED light source manufactured by Osram to verify its capability to fix CO₂. Consider the carbon footprint: each kilowatt-hour of electricity generated by a First Solar PV module will cause 6.15 g of CO₂ emission. And for each kilowatt-hour of electricity fed into an Osram LED light source of 30.4% conversion efficiency, it generates additional 12 g of CO₂, and generates 0.304 kWh equivalent of photons. So the accumulated carbon dioxide emission is 6.15 g (from PV)+12 g (from LED) CO₂ e/kWh=18.15 g CO₂ e/kWh. For each one kilowatt hour electric energy generated by the PV panel that goes into the LED, 0.304 kWh equivalent of photons are generated from it. Each 7.92 kWh equivalent photon can fix one kilogram of CO₂ molecules. Therefore 0.304 kWh equivalent of photons can fix 38.4 gram of CO₂ molecules, which is almost 2 times the CO₂ emission from the system. According to the description presented herein, a skill artisan will be able to construct a system by combining a power source with a carbon footprint of 18 g CO2/kWh and an LED light source with a carbon footprint of 20 g CO₂/kWh. When the light from the LED light source is absorbed by a plant matter, carbon dioxide molecules will be fixed through plant photosynthesis, and the number of CO₂ fixed by the system will exceed the LCA carbon emission of the system,

Even considering that a small portion of photons will be reflected from the surface of the plant and not taking part in the plant photosynthesis action, the majority of the photons that are absorbed will be more than sufficient to fix the CO₂ molecules emitted into the earth atmosphere according to LCA.

### Detail Description of Embodiment

In additional to the summary presented above, the invention will be further illustrated through the detail description of the following embodiments.

### EXAMPLE

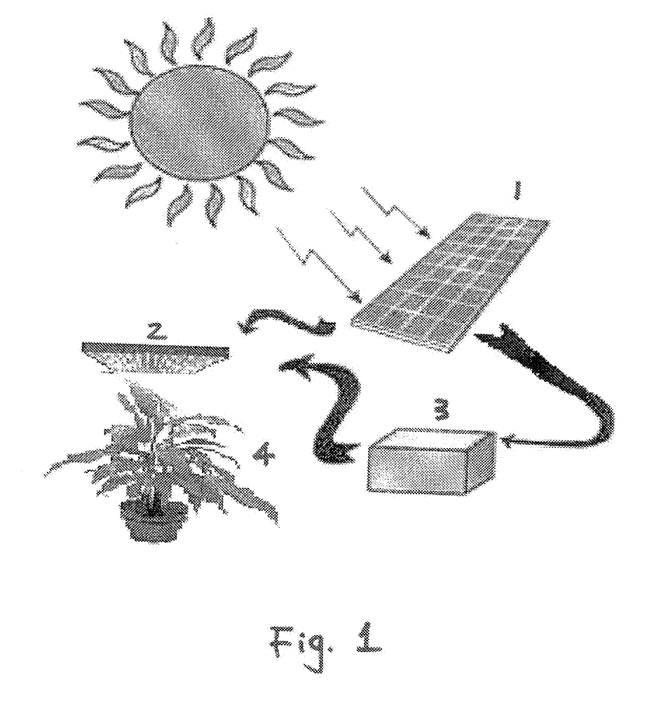

FIG. 1 depicts the components of a carbon negative system that embodies certain aspects of this invention. Element 1 depicts a solar panel that may be positioned to face the sun. Element 2 depicts an LED light source, which in this embodiment is arranged to shine directly on a growing plant 4, which may be algae. Element 3 depicts an optional battery that is connected to the solar panel 1 and to the LED light source 2. Element 3 may also include an optional voltage converter that converts the DC voltage from the solar panel into AC voltage.

As explained in previous section of this paper, the solar panel and the LED light source both carry their respective carbon footprint. The exemplary solar panel from First Solar has a carbon footprint of 6.15 g CO₂ e/kWh according to Inventor's calculation, and the exemplary LED from Osram has a carbon footprint of 3.65 g CO₂ e/kWh. As illustrated in previous sections of this paper, the combination of such a solar panel and a LED light source will be able to fix the total CO₂ emission for the life span of the solar panel and the LED light source when the LED light source is directed to a growing plant, with allowance for light reflection from the plant surface and component performance degradation due to aging.

### EXAMPLE 2

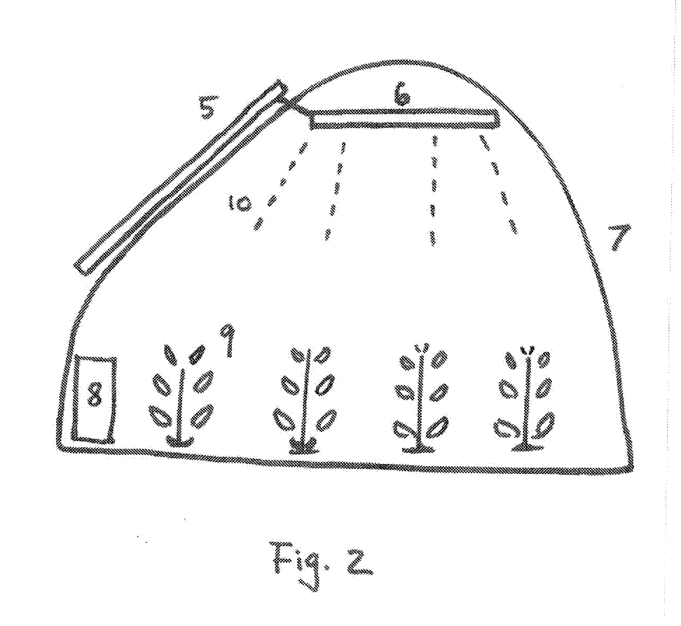

FIG. 2 depicts another embodiment of this invention, the system including a solar panel 5 affixed to a greenhouse 7, which may be configured to grow plants include algae. The solar panel, which is exposed to sunlight, has a carbon footprint of 6.15 g CO₂ e/kWh may be direct connected to an LED light source 6, which has a carbon footprint of 3.65 g CO₂ e/kWh, or indirectly through a battery as depicted in element 8. This system is able to fix the CO₂ emission from the combination of the solar panel and the LED light source when the photons 10 are directed to growing plants 9 including algae. Element 8 may also include an optional voltage converter that converts the DC voltage from the solar panel into AC voltage.

### EXAMPLE 3

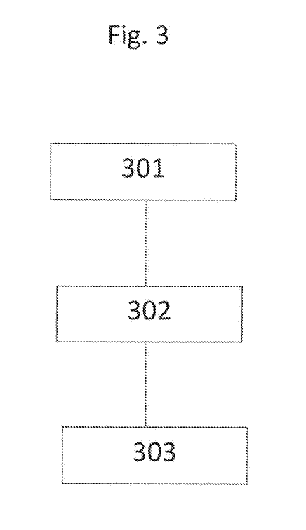

FIG. 3 depicts the process of construction of a system that can achieve carbon negativity. The process includes the following steps. At step 301, one selects a solar panel that has a carbon footprint of 6.15 g CO₂ e/kWh or lower and a LED light source that has a carbon footprint of 3.65 g CO₂ e/kWh or lower and a conversion efficient of 30.4% or higher. At step 302, one connects the solar panel, which may be affixed to a greenhouse and exposed to sun light, to the LED light source. The connection may also be through an optional battery and converter. At step 303, one directs the photons generated by the LED light source to growing plants including algae, which absorb the majority of the photons with a small amount of photons reflected from the surface of the plants.

The selection of solar panel from the First Solar and the LED light source from Osram for constructing the exemplary carbon negative system is only for illustration purposes. Before this invention, specific carbon footprint data from solar panel and LED light source are not readily available to the public. The limitations in the appending claims on the solar panel and the LED light source are based on what are commercially available to person skill in the art. It is contemplated that as technology progresses, the availability will increase.

The above selection of a solar panel as the power source does not limit the scope of the invention, which can be applied to new systems that include an electric power source having a finite carbon footprint, which when added to the carbon footprint of the light source, the total carbon footprint is less than the amount of carbon dioxide that can be fixed through plant photosynthesis by the light in terms of photons. Nuclear power, wind power, and geothermal power, all of which have been contemplated by Inventor as viable candidates at present or in the rear future and they are within the scope of this invention.

What is claimed is:

1. A carbon negative system, comprising:
a solar panel having a carbon footprint of 18 g CO₂ e/kWh or less; and
an LED light source having a carbon footprint of 20 g CO₂ e/kWh or less and a conversion efficiency of 30.4% or higher coupled to the solar panel.

2. The system of claim 1 in which the solar panel is connected to the LED with an intervening battery.

3. The system of claim 2, which further comprises a voltage converter.

4. The system of claim 1, further comprising a growing plant to which the LED light source is directed.

5. The system of claim 1, in which the solar panel is configured to face the sun.

6. A carbon negative system, comprising:
a greenhouse;
a solar panel affixed on the green house and having a carbon footprint of 18 g CO₂ e/kWh or less; and
an LED light source having a carbon footprint of 20 g CO₂ e/kW or less and a conversion efficiency of 30.4% or higher coupled to the solar panel.

7. The system of claim 6, in which the solar panel is connected to the LED with an intervening battery.

8. The system of claim 7, which further comprises a voltage converter.

9. The system of claim 6, further comprising growing plants to which the LED light source is directed.

10. The system of claim 6, in which the solar panel is configured to face the sun.

11. A process of constructing a carbon negative system, comprising the steps of:
selecting a solar panel having a carbon footprint of 18 g CO₂e/kWh or less;
selecting an LED light source having a carbon footprint of 20 g CO₂ e/kWh or less and conversion efficiency of 30.4% or higher; and
connecting the solar panel to the LED light source through an optional intervening battery.

12. The process of claim 11, in which the solar panel is connected to the LED without an intervening battery.

13. The process of claim 11, which further comprises connecting a voltage converter to the battery.

14. The process of claim 11, further comprising growing a plant by directing the LED light source is to the plant.

15. The process of claim 11, further comprising tuning the solar panel to face the sun.

16. A process for constructing a carbon negative system, comprising the steps of:
providing a greenhouse;
affixing a solar panel on the green house, the solar panel having a carbon footprint of 18 g CO₂e/kWh or less;
providing an LED light source having carbon foot print of 20 g CO₂ e/kWh or less and conversion efficiency of 30.4% or higher; and
connecting the LED connected to the solar panel through an optional intervening battery.

17. The process of claim 16, in which the solar panel is connected to the LED without an intervening battery.

18. The process of claim 18, which further comprises providing a voltage converter.

19. The process of claim 16, further comprising growing plants to which the LED light source is directed.

20. The process of claim 16, further comprising configuring the solar panel is to face the sun.
